(19) United States
(12) Patent Application Publication
(10) Pub. No.: US 2016/0362094 A1
(43) Pub. Date: Dec. 15, 2016

(54) METHOD FOR OPERATING A VEHICLE BRAKE SYSTEM

(71) Applicant: Ford Global Technologies, LLC, Dearborn, MI (US)

(72) Inventors: Thomas Svensson, Leichlingen (DE); Tim Jurkiw, Macomb, MI (US)

(73) Assignee: Ford Global Technologies, LLC, Dearborn, MI (US)

(21) Appl. No.: 15/179,732

(22) Filed: Jun. 10, 2016

Related U.S. Application Data
(63) Continuation-in-part of application No. 15/151,628, filed on May 11, 2016.

(30) Foreign Application Priority Data
Jun. 12, 2015 (DE) 102015210834.1

(51) Int. Cl. B60T 8/1761; B60T 8/24; B60T 8/1763

(52) U.S. Cl. CPC B60T 8/1761; B60T 8/1763; B60T 8/241; B60T 8/245; B60T 2270/12; B60T 2270/82

(57) ABSTRACT

A method for controlling a brake system of a motor vehicle wherein a central generation of brake-fluid pressure takes place electrically and essentially mechanically decoupled from the movement of a brake-actuating element. The brake pressure of individual wheels can be selectively modified depending on driving-dynamics parameters by activating hydraulic check-valve and drain-valve elements. In the case of braking events occurring before stability and/or slip limits are reached, which limits would make it necessary to use the antilock braking system and/or a stability program, the brake pressure is reduced such that the use of the hydraulic valve elements for the antilock brake system and/or the stability program is time-delayed. Further, blocking the supply of brake fluid to individual wheels or creating pressure-decrease states for individual wheels is minimized with respect to time.

### CROSS-REFERENCE TO RELATED APPLICATIONS

This application is a continuation-in-part of U.S. patent application Ser. No. 15/151,628 filed on May 11, 2016. The disclosure of the above application is incorporated herein by reference.

### BACKGROUND OF THE INVENTION

1. Field of the Invention

The present invention relates to a method for operating a vehicle brake system, and more specifically to a method for limiting brake pressure to a predetermined pressure value.

2. Description of Related Art

Numerous embodiments of vehicle brake systems exist. Anti-lock brake systems (ABS systems) are often part of an electronic stability control system (ESP). Brake systems may vary from the classic hydraulic dual circuit brake systems with a tandem master brake cylinder and hydraulic brake booster to electric motor supported brake systems or Brake-by-Wire systems (BBW). Brake-by-Wire systems using limited mechanical or hydraulic connections between the brake pedal and the brakes. In principle, Brake-by-Wire systems allow greater influence on the brake system by the vehicle control systems.

A BBW brake system may allow adjustment of the main brake cylinder, in the control mode (i.e., apart from special operating modes such as an emergency mode), by an electric motor, essentially mechanically independently of the actuation of a brake pedal. For the limp home mode, e.g., the electric motor or the power supply fails; a mechanical connection to the brake pedal can nevertheless become effective, therefore “essentially” mechanically decoupled.

A mechanical decoupling allows for various control-related interventions into the braking procedure, whereby, in particular, the response speed of the brakes can also be improved under adverse operating conditions, and functions such as emergency brake assist, cleaning of the brake pads by briefly applying the brake shoes, etc., can be substantially more easily implemented.

In general, a BBW brake systems generates brake pressure via an electric motor centrally for all wheels of the vehicle, similar to a conventional tandem main brake cylinder. The electric motor moves a piston of a corresponding brake cylinder via a spindle. Alternatively, the electric motor can also convert the rotary movement into a brake pressure in another way, e.g., in the manner of a pump.

To allow the brake torques of the individual wheels to be acted upon individually in an ABS (antilock braking system) or ESP (electronic stability program) or comparable driving assist systems, in such systems—similar to conventional hydraulic brake systems—magnetically actuated valves are usually provided, which can usually isolate (intake valve) every single wheel from the pressure generation, wherein one valve per wheel is usually also provided, by means of which the particular brake can be connected to a pressureless reservoir, whereby every single brake can be individually released.

With known ABS systems, to control these valves, the slip of each wheel is measured and, when a predetermined slip limit is reached, the ABS is activated.

In a heavy braking process, in particular emergency braking, a conventional brake system rapidly builds up brake pressure, wherein the brake pressure often rises to high values within the specifications of the brake system.

Often the braking effect resulting from the high brake pressure is not fully converted into a corresponding deceleration of the vehicle, because the deceleration depends in particular on the respective road and weather conditions and the resulting adhesion coefficient p. If the brake force can no longer be converted, wheel slip or wheel locking occurs, which is counteracted in a known way by the ABS, including a targeted reduction of the brake forces on individual wheels or a group of wheels. During a braking process, a situation can develop dynamically. For example when changing from a road surface with high μ (with correspondingly good traction conditions) to a road surface with lower μ (poorer traction conditions—such as wet, snow or ice etc.), often referred to as a negative μ-step. Vehicle dynamics control must react to this rapidly by pumping out low pressure brake fluid accumulators to counteract locking of the rear wheels. Reducing brake pressure, to avoid locking of the individual wheels, can be a problem at high brake pressures.

Further, especially at lower μ values, high brake pressures may cause an unwanted increase in the NVH values (NVH=Noise, Vibration, Harshness).

### SUMMARY OF THE INVENTION

A method of operating a brake system of a motor vehicle having a plurality of brake cylinders, each cylinder associated with a wheel. The method including generating a hydraulic brake pressure and providing a brake-actuating element associated with the wheel. Providing a plurality of hydraulic valve elements, including check-valve and drain-valve elements, associated with the brake system, and reducing hydraulic brake pressure without using the hydraulic valve elements for a period of time prior to activating the hydraulic valve elements.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow chart of one embodiment of the inventive method.

FIG. 2 is a flow chart of an additional embodiment of the inventive method.

### DETAILED DESCRIPTION OF THE PREFERRED EMBODIMENTS

The following description of the preferred embodiment(s) is merely exemplary in nature and is in no way intended to limit the invention, its application, or uses.

The problem addressed by the present invention is that of optimizing the control of an ABS system or comparable driving-dynamics assist systems in the case of BBW systems of the initially mentioned type.

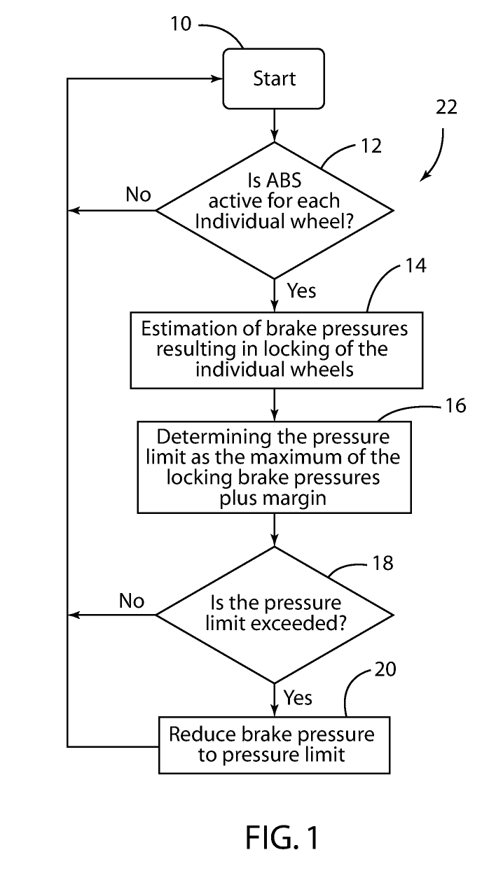

Referring to FIG. 1, one embodiment 22 of the inventive method is shown. The method 22 starts at step 10. Initially, at step 12, the method determines whether the ABS mode of the brake system 1 is active for each individual wheel. If not, the method returns to 10 and waits until this condition exists. In an additional embodiment, the determination is implemented as part of a corresponding ABS control routine whereby the determination becomes unnecessary.

Alternatively, it is also conceivable to use the invention for other states in which limiting of the brake pressure is foreseeable, for example in certain ESP uses or applications.

If each individual wheel is in ABS mode, then step 14 estimates a separate brake pressure value for each individual wheel that, if applied, would lock that individual wheel. Different methods for estimating brake pressure values are known in the context of ABS control. One method includes measurement and analysis of the current wheel slip whereby the ABS system obtains a brake pressure value based on an estimation of the pressure value at which each wheel, brake-controlled by the anti-lock brake system, is about to lock. The brake pressure value at which locking of each wheel is incipient being necessary for control of the anti-lock brake system and therefore preferably provided by an ABS control unit.

In step 16 the highest brake pressure value is selected from the brake pressure values for each wheel determined in step 14 and a margin of typically 10 to 25 bar is added to the highest brake pressure value to determine the brake pressure limits to be subsequently used. For example, the brake pressure value for each wheel is compared and the highest value from each of the four wheels is selected as the brake pressure limit. The margin of preferably 10 to 25 bar is added to the determined brake pressure limit to provide an adequate brake pressure reserve for sudden changes in the braking conditions, for example due to an improvement of the traction behavior of the road surface. In the disclosed embodiment, the brake pressure margin being available until a higher maximum pressure value is determined based on updated ABS data, preferably during a regular recalculation, wherein the margin is once again added to the brake pressure limit value.

It is then determined, step 18, whether the current brake pressure generated by pressure generating device, in one example the hydraulic brake cylinder, exceeds the brake pressure limit value, including the margin, established in step 16. In the present example, a pressure sensor measures the current brake pressure generated by the hydraulic brake cylinder. The measured pressure is compared to the brake pressure limit value to determine whether it exceeds brake pressure limit value.

If the measured pressure exceeds the brake pressure limit value, in step 20, the brake pressure is reduced to the brake pressure limit value. The reduction carried out continuously in a ramped manner, or damped with a low-pass filter, in a plurality of steps/loop passes to avoid pressure pulses when the measured pressure exceeds the newly predetermined pressure limit thereby reducing driver perception of the reduction.

In the case of an electrically assisted brake system, an electric motor causes a suitable correction of the pressure by influencing the master brake cylinder or with an additional cylinder. In the case of a Brake-by-Wire system, a controller monitoring the respective pressure values and set points actuates the electric motor as necessary to adjust brake pressure as needed.

The method starts then returns again to step 10 to take into account any changes in the ABS operating conditions (for example changes of the p values, deactivation of the ABS system). If the conditions for the brake pressure reduction are no longer met (for example the end of the ABS mode), the ABS system is deactivated (not shown).

As disclosed for a BBW system of the initially mentioned type, in the case of braking events occurring before stability and/or slip limits are reached, limits making it necessary to use the antilock braking system and/or a stability program, generation of brake pressure is reduced. The reduction such that the use of the hydraulic valve elements for the antilock brake system and/or the stability program is time-delayed and/or states in which the supply of brake fluid to individual wheels is blocked or pressure-decrease states for individual wheels are minimized with respect to time.

As a result, before the use of the ABS or the ESP, increase in brake pressure—centrally for all wheels—can be limited, so that the braking can be carried out longer with low slip, in particular during sudden increases in brake pressure (e.g., during emergency braking, boosted by an emergency brake assist if necessary). Furthermore, the brake pressure can be adjusted more rapidly, more precisely, and in a more highly metered manner than would be possible by actuating solenoid valves, which usually allows only two switching states.

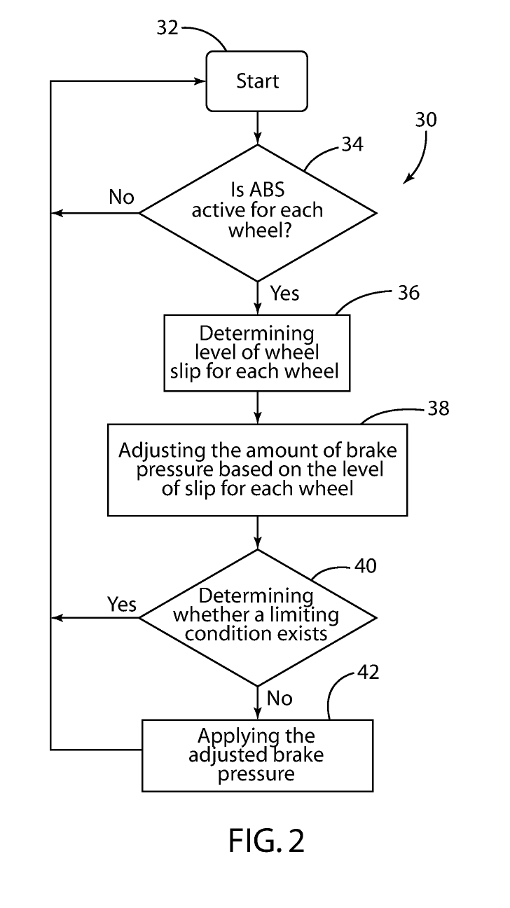

FIG. 2 illustrates another embodiment wherein generation of brake pressure can be reduced when the slip of an individual wheel reaches the estimated actual slip limit for this wheel by a predetermined percent and/or when the measured deceleration rate of the vehicle during a braking procedure drops by a predetermined value. These parameters are usually constantly monitored by the brake control of a vehicle with respect to a possible activation of the ABS, so that the corresponding values are available. The reduction of the generation of brake pressure preferably takes place when the corresponding slip limit has already been exceeded at one of the wheels, with consideration for the conditions described further below, if necessary.

Referring to FIG. 2, an additional embodiment 30 of the inventive method is shown. The method 30 starts at step 32. Initially, at step 34, the method determines whether the ABS mode of the brake system is active for each individual wheel. If not, the method returns to 32 and waits until this condition exists. In an additional embodiment, the determination is implemented as part of a corresponding ABS control routine whereby the determination becomes unnecessary.

If each individual wheel is in ABS mode, then step 36 determines the level of wheel slip for each wheel. In step 38 the brake pressure is adjusted based on the level of slip for each wheel. The specifically selected percentage for the ABS slip limit for the onset of the generation of brake pressure, which has been reduced according to the present example, can be dynamically adjusted depending on various vehicle parameters such as, for example, the temperature, the position of the wheel on the vehicle having the limit-exceeding slip (in particular independently of whether the front or the rear axle is affected), etc. Typical percentages are between 70 to 95% of the ABS-triggering slip limit. In addition, the deceleration rate of the vehicle can also be a triggering criterion (deceleration rate>X g/s, wherein g=9.81 m/s2).

In one example, the adjustment, including reduction of brake pressure, includes a reduction of the torque of the drive motor of the electric motor for generating brake pressure, a stabilization of the torque, or a decelerated increase of the drive-motor torque. There need not be a reduction in torque, but rather that only the increase regarding the torque curve can also be reduced without the reduction intervention according to the invention, which is why a slower increase in the engine torque can also be included in the reduction of brake pressure.

Step 40 includes determining whether a limiting condition exists, wherein reduction of the generation of brake pressure can be attenuated or not implemented. Examples of a limiting condition include one or more of the following conditions:ambient temperature is below a predetermined temperature threshold (e.g., signaling a risk of frost); driving on a wet road surface, which can be detected, in particular, when a windshield wiper speed selected by the driver exceeds a predetermined speed or with a rain sensor; the road-surface grade exceeds a predetermined threshold value (braking on a steep downhill road); the slip difference between two wheels on a common axle exceeds a predetermined slip difference (a central reduction of the generation of brake pressure would adversely affect the lower-slip braking); the yaw stability index of the vehicle exceeds a predetermined yaw stability index threshold value; and/or the steering angle exceeds a predetermined steering-angle threshold value (a wheel-specific reduction of brake pressure is preferred in the latter cases). The foregoing are merely examples and other limiting conditions may also exist.

The criteria indicate braking situations that tend to be more critical, in which wheel-specific metering of the braking force is more significant, so that a transition is preferably made directly to the classic ABS or EPS programs.

Step 42 includes applying the adjusted brake pressure.

In an additional embodiment of the invention, the starting point and/or the extent of the reduction of the generation of brake pressure can be controlled as a function of the present brake-fluid viscosity, wherein the start of the reduction is delayed or the extent of the reduction is reduced in the case of low-viscosity brake fluid. Viscosity-related variations of the braking behavior (in particular at low temperatures) can therefore be equalized.

The reduction of the generation of brake pressure during a valve-induced blockage of the brake-fluid supply is adjusted at one or more individual brakes, in particular that the generation of brake pressure is additionally reduced. Such a valve-induced blockage occurs, in particular during an ABS operation. An undesirably rapid increase in brake pressure at the remaining wheels having open intake valves is prevented with a corresponding adjustment of the reduction of the generation of brake pressure.

In an additional example, if the ABS is activated simultaneously for all wheels, the generation of brake pressure is logically temporarily halted.

The control for a brake system of a motor vehicle carries out a central generation of brake-fluid pressure for all wheels during normal operation, while electrically and essentially mechanically decoupled from the movement of a brake-actuating element, and in which, within an antilock braking system and/or an electronic stability program, the brake pressure of individual wheels can be selectively modified depending on driving-dynamics parameters by activating hydraulic check-valve and drain-valve elements, wherein the control for carrying out a method is designed as described above. The disclosed examples provide for a more precise metering of braking force than would be possible by activating conventional solenoid valves. Making it is possible to react in critical braking situations more rapidly than in the prior art, wherein system can optimally and synergistically interact with a conventional ABS or EPS control while using solenoid valves. The system makes it possible to avoid draining brake fluid to reduce brake pressure in certain situations, since excess brake pressure can be avoided in advance with a proactive reduction of the generation of brake pressure.

It is possible to equalize fluctuations in the viscosity of the brake fluid resulting from temperature fluctuations and to ensure a constant brake characteristic across a wide temperature range.

Proactive reduction of brake pressure, according to the disclosed examples, before the ABS slip limits are reached, enables achieving a shorter emergency braking path under good road conditions.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for operating a vehicle brake system comprising:
generating a hydraulic brake pressure;
providing a brake-actuating element associated with a wheel;
providing a plurality of hydraulic valve elements, including check-valve and drain-valve elements, associated with the brake system; and
reducing hydraulic brake pressure without the use of the hydraulic valve elements for a period of time prior to activating the hydraulic valve elements.

2. The method of claim 1 wherein the brake pressure is reduced when the slip of an individual wheel reaches the estimated actual slip limit for this wheel by a predetermined percent.

3. The method of claim 1 wherein the brake pressure is reduced when the measured deceleration rate of the vehicle during a braking procedure drops by a predetermined value.

4. The method of claim 1 including a reduction of the torque of a motor for generating brake pressure, a stoppage of the motor, or a decelerated increase of the motor torque.

5. The method of claim 1 wherein the reduction of brake pressure is attenuated or not implemented when one or more of the following conditions is met: the ambient temperature is below a predetermined temperature threshold;
driving on a wet road surface, which can be detected, in particular, in that a windshield wiper speed exceeds a predetermined speed; the road-surface grade exceeds a predetermined threshold value; the slip difference between two wheels situated on a common axle exceeds a predetermined slip difference; the yaw stability index of the vehicle exceeds a predetermined yaw stability index threshold value; and/or the steering angle exceeds a predetermined steering-angle threshold value.

6. The method of claim 1 wherein reduction of brake pressure is controlled as a function of the brake-fluid viscosity, wherein the start of the reduction is delayed or the extent of the reduction is reduced in the case of low-viscosity brake fluid.

7. The method of claim 1 wherein the reduction of brake pressure during a valve-induced blockage of the brake-fluid supply is adjusted at one or more individual brakes.

8. A method for controlling a brake system of a motor vehicle, in which, in the control mode, a central generation of brake-fluid pressure takes place electrically and essentially mechanically decoupled from the movement of a brake-actuating element, and in which, within the scope of an antilock braking system and/or an electronic stability program, the brake pressure of individual wheels can be selectively modified depending on driving-dynamics parameters by activating hydraulic check-valve and drain-valve elements, wherein in the case of braking events occurring before stability and/or slip limits are reached, which limits would make it necessary to use the antilock braking system and/or stability program the steps of:
reducing the electric generation of brake pressure in such a way that the use of the hydraulic valve elements for the antilock brake system and/or the stability program is time-delayed and/or states in which the supply of brake fluid to individual wheels is blocked, or pressure-decrease states for individual wheels, are minimized with respect to time.

9. The method of claim 8 wherein the electric generation of brake pressure is reduced when the slip of an individual wheel reaches the estimated actual slip limit for this wheel by a predetermined percent and/or when the measured deceleration rate of the vehicle during a braking procedure drops by a predetermined value.

10. The method of claim 8 wherein the reduction of the electric generation of brake pressure preferably includes a reduction of the torque of the drive motor of the electric motor for generating brake pressure, a stoppage of the electric motor, or a decelerated increase of the drive-motor torque.

11. The method of claim 8 wherein the reduction of the electric generation of brake pressure is attenuated or is not implemented at all when one or more of the following conditions is met:
the ambient temperature is below a predetermined temperature threshold;
driving on a wet road surface, which can be detected, in particular, in that a windshield wiper speed exceeds a predetermined speed;
the road-surface grade exceeds a predetermined threshold value;
the slip difference between two wheels situated on a common axle exceeds a predetermined slip difference;
the yaw stability index of the vehicle exceeds a predetermined yaw stability index threshold value; and/or
the steering angle exceeds a predetermined steering-angle threshold value.

12. The method of claim 8 wherein the starting point and/or the extent of the reduction of the generation of brake pressure are controlled as a function of the present brake-fluid viscosity, wherein the start of the reduction is delayed or the extent of the reduction is reduced in the case of low-viscosity brake fluid.

13. The method of claim 8 wherein the reduction of the generation of brake pressure during a valve-induced blockage of the brake-fluid supply is adjusted at one or more individual brakes, in particular that the generation of brake pressure is additionally reduced in this case.

14. The method of claim 1 wherein the hydraulic brake pressure is reduced only when the brake cylinders of all wheels are activated by an anti-lock brake system.

15. The method of claim 1 including a hydraulic brake cylinder with an electric motor brake boosting component for generating the hydraulic brake pressure wherein any reduction of hydraulic brake pressure is conducted by the electric motor brake boosting component.

16. The method of claim 1 including using a mechanically decoupled brake pedal to generate hydraulic brake pressure.

17. The method of claim 1 wherein any change in hydraulic brake pressure is made continuously over a predetermined period to avoid sudden pressure changes.

18. The method of claim 1 including the step of using a controller and a motor to increase or decrease hydraulic brake pressure thereby maintaining the hydraulic brake pressure above a pressure limit.
